(19) United States
(12) Patent Application Publication
(10) Pub. No.: US 2026/0111192 A1
(43) Pub. Date: Apr. 23, 2026

(54) ELECTRONIC SYSTEM FOR MIDDLEWARE SOFTWARE GENERATION

(71) Applicant: Heineken Supply Chain B.V., Amsterdam (NL)

(72) Inventor: Guus GROENEWEG, Amsterdam (NL)

(21) Appl. No.: 19/118,003

(22) PCT Filed: Jan. 15, 2024
(86) PCT No.: PCT/NL2024/050015

§ 371 Date: Apr. 3, 2025

(30) Foreign Application Priority Data
Jan. 13, 2023 (EP) 23151619.6

(51) Int. Cl. G06F 8/36; H04L 9/40

(52) U.S. Cl. CPC G06F 8/36; H04L 63/0272

(57) ABSTRACT

Large companies use may different data management systems for, among others, CRM, ERP, warehouse management, HR, banking and purchasing. Each system uses data object for, for example, customer data or purchase orders-but each system in different formats. A method and system are provided for retrieving specification data on a first electronic data management system and a second electronic data management system. The system disclosed receives, for example from a user, specifications of the data objects and of the two electronic data management systems. Next, communication data, like gateway data, is retrieved as well as format data how the data object is formatted by both systems. Based on the reference data—described in business terms—the disclosed system retrieves executable or pre-executable data to compile software for porting the data object from the first format to the second format. WO

### TECHNICAL FIELD

The various aspects and variations thereof relate to providing an interface for communication of one or more data objects between two or more enterprise data management and processing systems, like, for example, enterprise resource planning—ERP—systems, CRM—Customer Relationship Management—systems, HR systems, banking systems and electronic procurement systems.

### BACKGROUND

Different enterprise data management systems may use different data formats for one and the same data object, for example a purchase order. This may be the result of difference in software architecture, but additionally or alternatively also a result of legacy; different systems may have been developed not being arranged to or not having to communicate with one another.

As a result, data objects present within both systems may be different data formats for, for example, customer data objects or purchase order data objects. Each system uses the same data objects, but in different formats. This may mean that particular records have different formats in different systems, but also that particular records present in one data format are not present in another data format. As different parts of a company are being integrated, such need for communication between ERP systems and compatibility for that may arise.

To keep the company running efficiently, middleware is required for porting data objects from one format to another format to enable seamless data communication between the system. Such interface platforms, known as middleware, are programmed using specifications provided by system integrators or other parties. Software for the middleware used to be custom made by IT departments.

US 2021/0133205 A1 discloses a system includes a processor configured to create a rule repository instance. The rule repository instance specifies a plurality of different procedures that facilitate specifying a sequence of transformer rules by cascading each of the procedures together using a dot notation format. The processor configures the rule repository instance with a plurality of transformer rules using the dot notation format. The processor receives data from a file arranged according to a first structured data format. The processor executes the sequence of transformer rules to convert data elements in the file to a second structured data format. The processor then provides for display or storage the data as converted into the second structured data format by the sequence of transformer rules.

### SUMMARY

This custom made process requires proper communication between business management and the IT departments—which is generally difficult with remote IT departments. The generation of middleware code may hence be a cumbersome process, as people may speak a different language—literally or figuratively—in particular as the compatibility and/or exchangeability between systems may be defined or desired by people with a business background, whereas the interface is programmed by software coders, with generally a technical background.

It is preferred to provide an efficient and modular way of providing interface functionality between two or more enterprise data management and processing systems for exchange of data between the two enterprise data management and processing systems.

A first aspect provides a method of providing an electronic data interface platform for communication of a data object from a first electronic system to a second electronic system, the method being executable by an electronic computing device. The method comprises receiving a first system reference of the first electronic system, receiving a second system reference of the second electronic system and receiving a data object reference of the data object. The method further comprises retrieving, using the first system reference, from an electronic reference database, first system connectivity data related to the first electronic system, retrieving, using the second system reference, from the electronic reference database, second system connectivity data related to the second electronic system, retrieving, from an electronic code repository, based on the first system connectivity data and the second system connectivity data, format base code for establishing format executable data arranged to convert the data object from a first data format related to the first electronic system to a second data format related to the second electronic system and retrieving, from the electronic code repository, based on at least one of the first system connectivity data and the second system connectivity data, gateway base code for establishing gateway executable data arranged to establish a communication gateway between the first electronic system and the second electronic system for transfer of the data object in the first data format from the first electronic system to the second electronic system, in the second data format. The data interface platform is provided by compiling the format executable data and the gateway executable data to provide an executable data object; and the executable data object is stored on an electronic storage medium.

This method enables efficient generation of an interface or middleware platform for electronic communication of data between two electronic data management systems. It is important that data related to each system is well managed, like data on IP addresses or other addresses, as well as data formats used by the systems for one and the same data object. Such data object may, for example, be a purchase order, to be sent from an ERP system to a purchasing system.

Some parts of the data object may have different formats. For example, a street address field may have a maximum length of 20 letters in a first format and 25 letters in another format. And in the first format, a separate record may be available for zip code, whereas the zip code may be included in the residence field in the second format. Based on this information, source code may already be available to port the first format to the second format—or the other way around. Alternatively or additionally, porting code may be automatically generated on demand.

Just the same, for communication to and from the first electronic system and the second electronic system, source code snippets may be available and retrieved based on one or more characteristics related to each of the electronic systems. These characteristics may be stored in a content management database, CMDB. The data in the CMDB may subsequently provide information, for each of the electronic systems, how to address routers and other gateway elements to ensure the data objects reach each of the systems.

This method thus allows for efficient generation of porting and communication software to be run on a middleware platform, such that data may be entered by a person who is not an IT specialist.

An implementation of the first aspect further comprises receiving resource requirement data providing an indication of resources required for communication of the data object; and retrieving, from the electronic code repository, based on the resource requirement data, resource management base code for establishing resource management executable data arranged to establish the communication between the first electronic system and the second electronic system in accordance with the resource requirement data, wherein providing the data interface platform further comprises compiling the resource management executable data into the executable data object.

Some data and data objects comprising such data require real-time two-way communication. An example thereof is data transmitted in cases where a payment and a confirmation thereof is part of an action for which data is to be communicated. In such example, actions need to be confirmed at application level as well, Furthermore, timing restrictions apply as such confirmation is preferably received as quickly as possible. However, if only monitoring data is to be transferred once per hour or twice per day, timing requirements are less strict and confirmation is only required at session or presentation level. This puts less strict requirements on system resources, which may be taken into account while assembling middleware porting protocols to provide tailor made software in an efficient way.

In another example, the resource requirement data comprises at least one of data related to size of the data object; and data related to communication frequency of the data object. Size of data objects may dictate requirements with respect to the way data is communicated. Small data objects can be sent quickly and will seldom suffer from (temporary) loss of connection. However, large data objects may take more time to be transmitted, over a longer time period during which it may be more likely that errors occur. In the latter case, the middleware software for porting and transmitting the data may be complemented with error handling instructions, like instructions how to resume data transmission rather than restarting data transmission.

In a further example, the resource requirement data provides an indication whether the data object is to be communicated in synchronous mode or asynchronous mode. This specification puts constrains how data is to be ported and transmitted between systems. For example, any other data stream with which the data transfer is to be synchronised with may be specified; this needs to be implemented in the middleware software.

Again another example further comprises receiving classification data providing an indication of a classification of the data object and retrieving, from the electronic code repository, based on the classification data, classification base code for establishing classification executable data arranged to establish the communication between the first electronic system and the second electronic system in accordance with the classification data; In this example, providing the data interface platform further comprises compiling the classification executable data into the executable data object.

With particular classifications of data, particular safety requirements may be set for transmission of data. For example, data may be classified as ‘privacy sensitive’ for data related to personnel or customers. Or data may be classified as ‘investor sensitive’, for example for financial company data prior to publication. Each classification may dictate a confidentiality level, a security level or another type of setting levels. And each level may indicate how data is to be transmitted: signed, encrypted, electronically certified, using password and username, using two-step verification, other, or a combination of two or more thereof.

In one further example, the classification data indicates a security level. Such security level may be at a security classification level, for example ‘open’, ‘low security’ and ‘high security’, or at a classification level like ‘open’, ‘confidential’ and ‘secret’. Alternatively or additionally, the security level may indicate technical features to be applied, like ‘encrypted’, ‘password protected’, ‘two-way verification required’, other or a combination of two or more thereof.

Yet a further example thus comprises retrieving security level data based on the classification data, wherein the classification executable data is arranged to provide security measures for the communication of the data object from the first electronic system to the second electronic system in accordance with the security level data corresponding to the classification data.

And yet another example further comprises, based on the classification data determining one or more security measures for the communication of the data object, wherein the retrieving of the classification base code comprises, per security measure, security base code for establishing security executable data to establish a security measure for securing the communication between the first electronic system and the second electronic system in accordance with the classification data.

In again a further example, the classification executable data for which the classification base code is intended is arranged to provide user authentication functionality prior to communication of the data object. Such user authentication may for example be provided by authentication of biometric data, like a fingerprint or an iris scan.

As discussed, in yet another example, the classification executable data for which the classification base code is intended is arranged to provide at least one of decryption, encryption, certifying, and signing of at least one of the data object in the first format and the data object in the second format.

In another example, gateway executable data, for which the gateway base code is intended, is arranged to communicate the data object to the second electronic system by routing the data object via at least one of a firewall and a virtual private network, the at least one of the firewall and the virtual private network being identified via at least one of the first connectivity data, the second connectivity data and the gateway data. Specific systems may require specific ways of addressing. One of these points is passing firewalls and other gateways, like for example routers. Particular systems may be dedicated gateways, for example dictated by customers or suppliers of the enterprise or by suppliers of the data management systems. By using proper administration of the gateway data and the systems, for example in a CMDB (Content Management Database), such data may be easily retrieved and further used for searching and selecting software snippets to assemble the middleware software.

Again a further example further comprises retrieving a reference data format for the data object for the data object, wherein format executable data for which the format base code is intended is arranged to convert the data object from the first data format to the reference data format and from the reference data format to the second data format. This example is particularly suitable for middleware platform that firstly port data in a format used by the first electronic server to an enterprise data model, a generic data model for the applicable data object. Such enterprise data model may be defined by the enterprise as a gold standard compatible with each format used for the applicable data model by all systems. An advantage is that less pre-programmed code for format conversion is required. With five different formats, generally 20 different options are possible for input and output data format. When not using an intermediate format, 20 different pieces of code are required. With this example, only 10 are required. And with fifteen different formats, this example reduces the amount of code snippets from 210 to 30.

A second aspect provides a computer program product comprising computer executable code causing a computer, when the code is loaded in a memory connected to a processing unit of the computer, to execute the method of the first aspect.

A third aspect provides a system comprising a processing unit programmed to executed a method of providing an electronic data interface platform for communication of a data object from a first electronic system to a second electronic system, the method being executable by an electronic computing device, the method being specified by the first aspect.

### BRIEF DESCRIPTION OF THE DRAWINGS

The various aspects and examples thereof will now be discussed in further detail in conjunction with drawings. In the drawings,

FIG. 1: shows an example of a data management system for an enterprise; and

FIG. 2: shows a flowchart depicting an example of a method that may be executed by the system depicted by FIG. 1.

### DETAIL DESCRIPTION

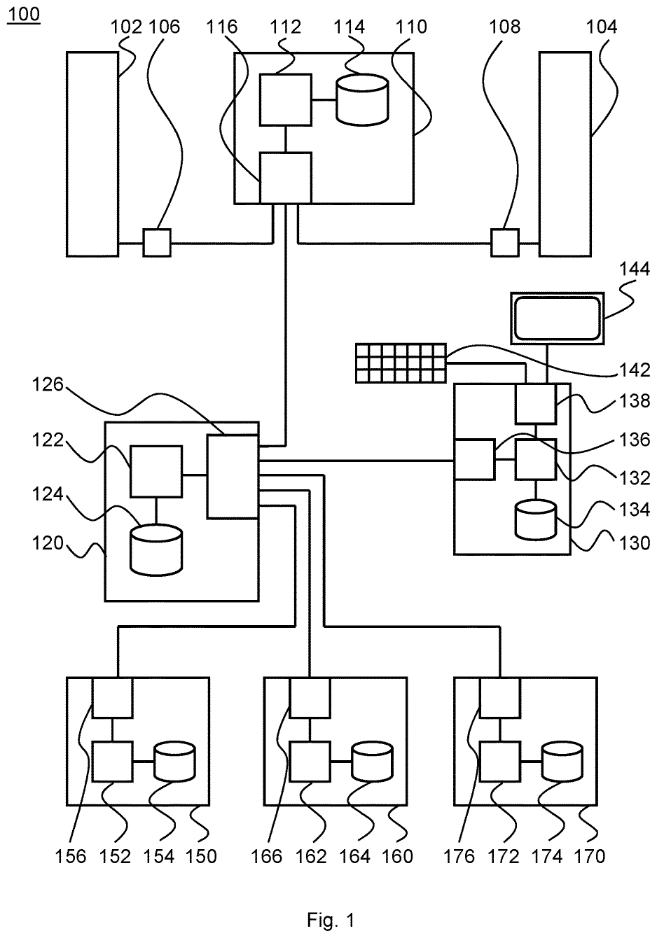

FIG. 1 shows an enterprise data system 100. The enterprise data system 100 comprises a first ERP system 102 and a second ERP system 104. ERP is short for enterprise resource planning, used by a company to manage key parts of operations, including accounting and resource management. This functionality is generally implemented in software. In other implementations, other enterprise data management and processing systems may be used, like CRM—Customer Relationship Management—systems and/or electronic procurement systems may be used. Examples of such software are SalesForce and SAP. The first ERP server 102 and the second ERP system 104 may be implemented as single physical computer or as a multitude of computers organised in a networked environment, either at one location or at different locations.

Between the first ERP server 102 and the second ERP system 104, a platform interface server 110 is provided for providing middleware functionality. The platform interface server 110 comprises an interface processing unit 112, an interface storage module 114 and an interface network communication module 116. The interface processing unit 112 is arranged to control operation of the platform interface server 110 as presented below. In order to provide the interface processing unit 112 with instructions for the operation, computer executable code may be stored in the interface storage module 114. Furthermore, data to be processed or having been processed may be stored in the interface storage module 114. The interface storage module 114 may be implemented as one or more of a hard disk drive, solid state memory, other, or combination thereof.

The interface network communication module 116 is connected to the first ERP system 102 via a first gateway 106 and to the second ERP system 104 via a second gateway 108. The first gateway 106 and the second gateway 108 may comprise one or more routers, firewalls, VPN (virtual private network) tunnels, other, or a combination thereof.

The platform interface server 110 is arranged to port—transform—data objects such that data objects may be exchanged between the first ERP system 102 and the second ERP system 104 if both servers use different data formats for one and the same data object. For example, a data object ‘customer’ may have in a first data format for the first ERP system 102 a field for ‘street address’ of 15 letters and in a second data format for the second ERP system 104 for 20 letters. Furthermore, a particular numerical field may be represented as a float in the first ERP system 102 and as a double in the second ERP system 104. Both the first data format and the second data format by be defined as compliant with an enterprise data model for the data object ‘customer’.

The platform interface server 110 is furthermore connected to an interface generator server 120. The interface generator server 120 comprises a generator processing unit 122, a generator storage module 124 and a generator network communication module 126. The generator processing unit 122 is arranged to control operation of the interface generator server 120 as outlined below. In order to provide the generator processing unit 122 with instructions for the operation, computer executable code may be stored in the generator storage module 124. Furthermore, data to be processed or having been processed may be stored in the generator storage module 124. The generator storage module 124 may be implemented as one or more of a hard disk drive, solid state memory, other, or combination thereof.

The generator communication module 126 is connected to the interface network communication module 116. Furthermore, the generator network communication module 126 is connected to a user terminal 130. The user terminal 130 is connected to a keyboard 142 as a user input device and an electronic display screen 144 as a user output device.

The user terminal 130 comprises a terminal processing unit 132, a processing storage module 134, a terminal network communication module 136 and a terminal user interface module 138. The terminal processing unit 132 is arranged to control operation of the user terminal 130 as outlined below. In order to provide the terminal processing unit 132 with instructions for the operation, computer executable code may be stored in the terminal storage module 134. Furthermore, data to be processed or having been processed may be stored in the terminal storage module 134. The terminal storage module 134 may be implemented as one or more of a hard disk drive, solid state memory, other, or combination thereof. The terminal user interface module 138 is connected to the keyboard 142 and the electronic display screen 144.

The enterprise data system 100 further comprises a content management database (CMDB) server 150. The content management database server 150 comprises a database processing unit 152, a database storage module 154 and a database network communication module 156. The database processing unit 152 is arranged to control operation of the content management database server 150 as outlined below. In order to provide the database processing unit 152 with instructions for the operation, computer executable code may be stored in the database storage module 152.

Furthermore, data processed or to be processed by the database processing unit 152 may be stored in the database storage module 154. The database storage module 154 may be implemented as one or more of a hard disk drive, solid state memory, other, or combination thereof. In this example, the database storage module 154 has stored data in it related to the first ERP system 102, the first gateway 106, the second ERP system 104 and the second gateway 108.

More in particular, the data related to the first ERP system 102, the first gateway 106, the second ERP system 104 and the second gateway 108 stored in the database storage module 154 may relate to the first data format and the second data format. Furthermore, data stored may provide information about one more of routers, firewalls, VPN (virtual private network) tunnels, other, or a combination thereof of at least one of the first gateway 106 and the second gateway 108. Alternatively or additionally, the data stored in the database storage module 154 may provide one or more network addresses of the first ERP system 102, the second ERP system 104, any element of at least one of the first gateway 106 and the second gateway 108.

The enterprise data system 100 further comprises a code repository server 160. The code repository server 160 comprises a repository processing unit 162, a repository storage module 164 and a repository network communication module 166. The repository processing module 162 is arranged to control operation of the code repository server 160 as outlined below. In order to provide the repository processing unit 162 with instructions for the operation, computer executable code may be stored in the repository storage module 162.

Furthermore, data processed or to be processed by the repository processing unit 162 may be stored in the repository storage module 164. The repository storage module 164 may be implemented as one or more of a hard disk drive, solid state memory, other, or combination thereof. In this example, the repository storage module 164 has interface code stored in it for programming the interface processing unit 112 to facilitate particular ways of exchange-communication-of data objects between the first ERP system 102 and the second ERP system 104.

The interface code may be provided in code snippets arranged for particular functionality. For example, code snippets may be provided to provide user authentication and user verification functionality, encryption and decryption functionality, two-way real time communication, asynchronous or synchronous communication or any other desired functionality for communication of data objects between the first ERP system 102 and the second ERP system 104, including porting of data objects from the first data format to the second data format.

The enterprise data system 100 further comprises a reference data server 170 the reference data server 170 comprises a reference processing unit 172, a reference storage module 174 and a reference network communication module 176. The reference processing module 172 is arranged to control operation of the reference data server 170 as outlined below. In order to provide the reference processing unit 172 with instructions for the operation, computer executable code may be stored in the reference storage module 172. Furthermore, data processed or to be processed by the refence processing unit 172 may be stored in the reference storage module 174. The reference storage module 174 may be implemented as one or more of a hard disk drive, solid state memory, other, or combination thereof.

In this example, the reference storage module has reference data stored in it to relate particular user demands or user requirements for communication of data objects between the first ERP system 102 and the second ERP system 104 to particular technical requirements. For example, a user may provide a classification of a data object to be communicated between the first ERP system 102 and the second ERP system 104. Such classification may be ‘confidential’ or ‘personal data’. In the reference storage module 174, reference data may be provided to relate the classification level to a particular security level. In turn, the security level may be linked to particular functionality to be facilitated for communication of data objects between the first ERP system 102 and the second ERP system 104. Such functionality may be encryption, decryption, signing, user authentication, user verification, either one-factor or two-factor, other, or a combination thereof. Further reference data may be provided like an enterprise data model for particular data objects to be communicated.

The content management database server 150, the code repository server 160 and the reference data server 170 are connected to the interface generator server 120 via the network communication modules of each of the servers. The connections may be routed, switched, other, or a combination thereof, directly or via a network.

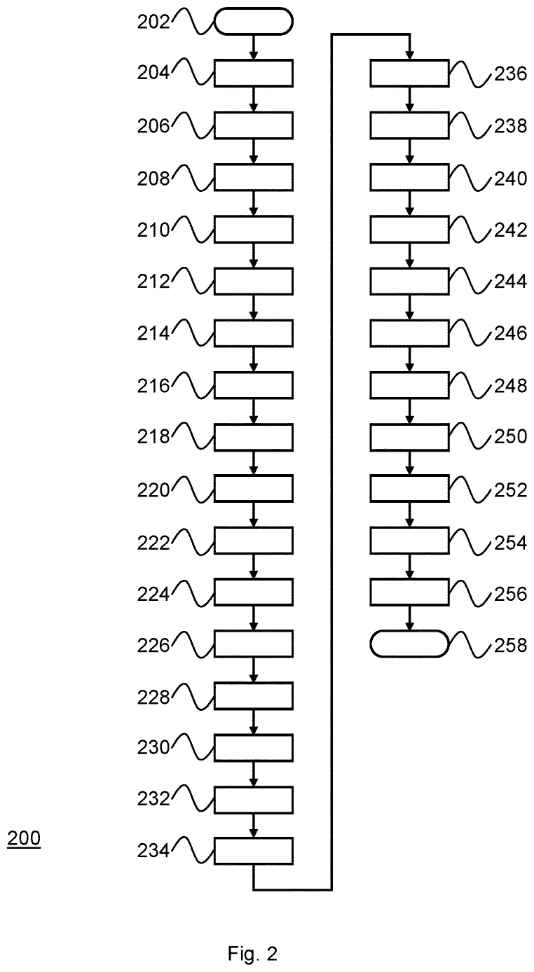

FIG. 2 shows a flowchart 200 depicting a procedure for generating an interface between the first ERP system 102 and the second ERP system 104 for exchange of one or more data objects, as an example of the first aspect.

The various parts of the flowchart 200 may be summarised as follows:
202 start procedure
204 receive reference data of the first ERP system
206 receive reference data of the second ERP system
208 receive reference data of the data object
210 receive resource data
212 receive a classification of the data object
214 retrieve first gateway data of the first ERP system
216 retrieve second gateway data of the second ERP system
218 retrieve format data of the first ERP system
220 retrieve format data of the second ERP system
222 retrieve a reference data model for the data object
224 retrieve security data related to the classification
226 determine security measures based on the security data
228 determine resource requirements based on the resource data
230 retrieve first gateway base code
232 retrieve second gateway base code
234 retrieve first format base code
236 retrieve second format base code
238 retrieve security base code
240 retrieve connectivity base code
242 compile base code to executable code
244 send executable code to platform interface server
246 receive
248 store
250 receive data
252 process data to enterprise data model format
254 process data to second format
256 send data in accordance with second format
258 end

The procedure starts in a starting terminal 202. The procedure is initiated by a user—which may be a human being or an electronic agent—requesting an interface between the first ERP system 102 and the second ERP system 104 for a particular data object, for example by means of the user terminal 130. The user is prompted for input related to the data object. The procedure proceeds to step 204, in which first system identifier data related to the first ERP system 102 is received. In step 206, second system identifier data related to the second ERP system 104 is received. The system identifier data received provides identification of the ERP systems, such that more detailed data on the ERP systems may be retrieved, for example from the content management database server 150.

In step 208, reference data related to the data object is retrieved from the reference data server 170. The reference data related to the data object to be communicated may provide an indication of content of particular records of the data object. Additionally or alternatively, the reference data related to the data object may be an enterprise data model or an enterprise data model format for the particular type of data object to be communicated.

In step 210, resource data is received. The resource data may provide an indication of resources required for communication of the data object between the first ERP system 102 and the second ERP system 104. Such resources specified may be a size of the data object, for example in terms of bits or bytes, a frequency of communication, for example in terms of an amount of data objects to be communicated per time unit, a data transfer speed required or desired, as a minimum transfer rate or average transfer rate, whether data transfer is synchronous or asynchronous, another requirement or a combination of two or more thereof.

In step 212, classification data related to a classification of the data object may be received. Such classification may provide data on a confidentiality level, for example ‘secret’, ‘confidential’, ‘for your eyes only’, other or a combination of two or more thereof. Additionally or alternatively, the classification data may indicate a type of data communicated, which implicitly provides an indication of how the data is to be handled. Such classification may be ‘personal data’, ‘commercial data’, ‘investor sensitive data’, other, or a combination of two or more thereof. In particular jurisdictions, communication of personal data of people—name, address, telephone number and the like—is bound to particular restrictions or security requirements.

In step 214, first gateway data related to the first ERP system 102 is retrieved from the content management database server 150 using the first system identifier data. The first gateway data provides data on addressing the first ERP system 102 and data on how to pass the first gateway 106. In step 216, second gateway data related to the second ERP system 104 is retrieved from the content management database server 150 using the second system identifier data. The second gateway data provides data on addressing the second ERP system 104 and data on how to pass the second gateway 108.

In step 218, first data format data related to the first ERP system 102 is retrieved from the content management database server 150 using the first system identifier data. The first data format data provides an indication how the first ERP system 102 formats or has formatted the data object to be communicated. In step 220, second data format data related to the second ERP system 104 is retrieved from the content management database server 150 using the second system identifier data. The second data format data provides an indication how the second ERP system 104 formats or has formatted the data object to be communicated.

In step 222, a reference data model is retrieved from the reference data server 170. The reference data model may provide an ideal format of the data object to be communicated. By nature, some ERP systems are not able to provide data in accordance with the reference data model and provide some parts of the data object in a simpler form.

In step 224, security data is retrieved from the reference data server 170, in accordance with the classification data received. The security data provides an indication of a security level related to the classification. The security level may be indicated by numbers, letters, in a custom way or any other way. A particular security level may, for example, relate to an upper limit of a probability of hacking required for the particular classification. As such, the security data may provide an indication how the communication of the data object is to be secured.

Based on the security data, in step 226, security measures to be applied are determined. Such security measures may for example by means of username and password, biometric user authentication, encryption of data, other, or a combination of two or more thereof. The security requirements may be dictated by or related to company policy, national or national legislation, other, or a combination of two or more thereof. It is noted that step 224 and step 226 may be executed as one; based on the classification, security measures may be directly determined.

In step 228, resource requirements are determined based on the resource data. Such resource requirements may be bandwidth, storage required, timeslot allocation, real-time two-way communication and confirmation of receipt of data to be sent, one-way communication, other, or a combination of two or more thereof.

In step 230, first gateway base code is retrieved from the code repository server 160, based on the first gateway data related to the first gateway 106. The first gateway base code may be source code in any programming language, like Python, C, Java, other or any combination of two or more thereof. Alternatively, the first gateway base code is obtained as object code. The first gateway base code enables, when compiled as outlined below, the interface processing unit 112 to address the first ERP system 102 via the first gateway 106. As such, the first gateway base code may comprise data on any router, firewall or other components in the first gateway 106, as well as an address of the first ERP system.

In step 232, second gateway base code is retrieved from the code repository server 160, based on the second gateway data related to the second gateway 108. The second gateway base code may be source code in any programming language, like Python, C, Java, other or any combination of two or more thereof. Alternatively, the second gateway base code is obtained as object code. The second gateway base code enables, when compiled as outlined below, the interface processing unit 112 to address the second ERP system 104 via the second gateway 108. As such, the second gateway base code may comprise data on any router, firewall or other components in the second gateway 106, as well as an address of the second ERP system.

In step 234, first format base code is retrieved from the code repository server 160, based on the first format data related to the first ERP system 102. A part of the first format data may be used for generating a query to search for the first format base code in the code repository server 160. Alternatively or additionally, a query may be generated based on other data identifying the first ERP system 102. In another implementation, the first format data comprises a query. In yet another implementation, the first format data provides information exactly where in the code repository server 160 the first format base code may be retrieved.

The first format base code may be source code in any programming language, like Python, C, Java, other or any combination of two or more thereof. Alternatively, the first format base code is obtained as object code. The first format base code enable the platform interface server 110 and the interface processing unit 112 in particular to process the data objected formatted in accordance with the first data format and in particular to extract data from the data object. Furthermore, if applicable, the first format base code may enable the interface processing unit to port the data object from the first data format to the enterprise data model format or to the second data format.

In step 236, second format base code is retrieved from the code repository server 160, based on the second format data related to the second ERP system 104. A part of the second format data may be used for generating a query to search for the second format base code in the code repository server 160. Alternatively or additionally, a query may be generated based on other data identifying the second ERP system 104. In another implementation, the second format data comprises a query. In yet another implementation, the second format data provides information exactly where in the code repository server 160 the second format base code may be retrieved.

The second format base code may be source code in any programming language, like Python, C, Java, other or any combination of two or more thereof. Alternatively, the second format base code is obtained as object code. The second format base code enable the platform interface server 110 and the interface processing unit 112 in particular to process the data objected formatted in accordance with the second data format and in particular to extract data from the data object. Furthermore, if applicable, the second format base code may enable the interface processing unit to port the data object from the first data format or from an enterprise data model format to the second data format.

In step 238, security base code is retrieved from the code repository server 160, based on at least one of the classification data, the security data and the security measures obtained or determined as discussed above. The security base code may be source code in any programming language, like Python, C, Java, other or any combination of two or more thereof. Alternatively, the second format base code is obtained as object code. The security base code enables the platform interface server 110 and the interface processing unit 112 in particular to process the data object in accordance with at least one of the classification data, the security data and the security measures obtained or determined as discussed above.

In step 240, connectivity base code is retrieve from the code repository server 160, based on at least one of the first gateway data, the second gateway data, the resource data or other data retrieved or obtained as indicated above. The connectivity base code may be source code in any programming language, like Python, C, Java, other or any combination of two or more thereof. Alternatively, the second format base code is obtained as object code. The connectivity base code enables the platform interface server 110 and the interface processing unit 112 in particular to handle communication of the data object in accordance with the at least one of the first gateway data, the second gateway data, the resource data or other data retrieved or obtained as indicated above.

In step 242, the base code retrieved as discussed above is compiled to computer executable code that enables the platform interface server to handle communication of the data object between the first ERP system 102 and the second ERP system 104 in accordance with the requirements as provided by the user. Compiling comprises combining the snippets of base code to one data object for programming the interface processing unit 112. This data object may comprise one or more files. The combining of snippets may be a mere aggregation of the base code. In such example, source code of different snippets may be put in one data object for execution. This may be in source code, for example for Java, or in object code. Alternatively, the compiling comprises transforming source code to object code.

The receiving of the data in steps 204 to 212 may be performed by at least one the user terminal 130 and the interface generator server 120. This applies to the retrieving steps 214 to 224 as well. Retrieval of the code snippets is preferably done by the interface generator server 120, but may be performed by the user terminal 130 as well. This applies to the compiling as well. In one implementation, functionality of the user terminal 130 and the interface generator server 120 may be implemented in one and the same hardware. This means that a computer programme product comprising executable code to perform the method as depicted by the flowchart 200 may be stored in the generator storage module 124 as a non-transitory medium or on the terminal storage module 134 as a non-transitory medium—or on both. In another implementation, the collection of data by the user terminal 130 is executed by the generator server 120, that provides an interface to the user terminal 130 as software as a service, for example via a web browser application.

In step 244, the compiled code is sent to the platform interface server 110, where it is received in step 246 by the interface network communication module 116 and stored in the interface storage module 114 in step 248. At this location, the compiled data may be retrieved by the interface processing unit 112 for execution to handle communication of the data object.

The handling of the data object starts by receiving the data object from the first ERP system 102, via the first gateway 106, in the first data format, in step 250. In step 252, the data object is ported to the enterprise data model format, if applicable. In step 254, the data object is ported to the second data format, either from the enterprise data model format or from the first data format. Subsequently, in step 256, the data object is sent to the second ERP system 104 in accordance with the second data format, via the second gateway 108.

The sending of the data object to the second ERP system 104 is performed in step 256 in accordance with the data received in the previous steps of the procedure as outlined by the flowchart 200, with encryption and decryption, if required and only after successful identification and/or authentication of a user requesting the data from the first ERP system 102 via the second ERP system 104 or of a user sending the data object from the first ERP system 102 to the second ERP system 104. Once the data object has been communicated accordingly, the procedure ends in a terminator 258.

The various steps as depicted by the flowchart 200 may be executed in a different order, in series or in parallel, unless this would not be feasible. Furthermore, certain steps may be omitted if particular data is not available, like resource data or classification data. This means that particular parts of the enterprise data system 100 may be omitted or implemented differently than depicted, depending on requirements of particular implementations of the various aspects provided here.

In summary, large companies use may different data management systems for, among others, CRM, ERP, warehouse management, HR, banking and purchasing. Each system uses data object for, for example, customer data or purchase orders—but each system in different formats. A method and system are provided for retrieving specification data on a first electronic data management system and a second electronic data management system. The system disclosed receives, for example from a user, specifications of the data objects and of the two electronic data management systems. Next, communication data, like gateway data, is retrieved as well as format data how the data object is formatted by both systems. Based on the reference data—described in business terms—the disclosed system retrieves executable or pre-executable data to compile software for porting the data object from the first format to the second format.

1. A method of providing an electronic data interface platform for communication of a data object from a first electronic system to a second electronic system, the method being executable by an electronic computing device, the method comprising:
receiving a first system reference of the first electronic system;
receiving a second system reference of the second electronic system;
receiving a data object reference of the data object;
retrieving, using the first system reference, from an electronic reference database, first system connectivity data related to the first electronic system;
retrieving, using the second system reference, from the electronic reference database, second system connectivity data related to the second electronic system;
retrieving, from an electronic code repository, based on the first system connectivity data and the second system connectivity data, format base code for establishing format executable data arranged to convert the data object from a first data format related to the first electronic system to a second data format related to the second electronic system;
retrieving, from the electronic code repository, based on at least one of the first system connectivity data and the second system connectivity data, gateway base code for establishing gateway executable data arranged to establish a communication gateway between the first electronic system and the second electronic system for transfer of the data object in the first data format from the first electronic system to the second electronic system, in the second data format;
providing the data interface platform by compiling the format executable data and the gateway executable data to provide an executable data object; and
storing the executable data object on an electronic storage medium.

2. The method according to claim 1, further comprising:
receiving resource requirement data providing an indication of resources required for communication of the data object; and
retrieving, from the electronic code repository, based on the resource requirement data, resource management base code for establishing resource management executable data arranged to establish the communication between the first electronic system and the second electronic system in accordance with the resource requirement data;
wherein providing the data interface platform further comprises compiling the resource management executable data into the executable data object.

3. The method according to claim 2, wherein the resource requirement data comprises at least one of:
data related to size of the data object; and
data related to communication frequency of the data object.

4. The method according to claim 2, wherein the resource requirement data provides an indication whether the data object is to be communicated in synchronous mode or asynchronous mode.

5. The method according to claim 1, further comprising:
receiving classification data providing an indication of a classification of the data object;
retrieving, from the electronic code repository, based on the classification data, classification base code for establishing classification executable data arranged to establish the communication between the first electronic system and the second electronic system in accordance with the classification data;
wherein providing the data interface platform further comprises compiling the classification executable data into the executable data object.

6. The method according to claim 5, wherein the classification data indicates a security level.

7. The method according to claim 6, further comprising retrieving security level data based on the classification data;
wherein the classification executable data is arranged to provide security measures for the communication of the data object from the first electronic system to the second electronic system in accordance with the security level data corresponding to the classification data.

8. The method according to claim 6, further comprising, based on the classification data determining one or more security measures for the communication of the data object;
wherein the retrieving of the classification base code comprises, per security measure, security base code for establishing security executable data to establish a security measure for securing the communication between the first electronic system and the second electronic system in accordance with the classification data.

9. The method according to claim 5, wherein the classification executable data for which the classification base code is intended is arranged to provide user authentication functionality prior to communication of the data object.

10. The method according to claim 5, wherein the classification executable data for which the classification base code is intended is arranged to provide at least one of:
decryption;
encryption;
certifying; and
signing
of at least one of the data object in the first format and the data object in the second format.

11. The method according to claim 1, wherein gateway executable data for which the gateway base code is intended is arranged to communicate the data object to the second electronic system by routing the data object via at least one of a firewall and a virtual private network, the at least one of the firewall and the virtual private network being identified via at least one of the first connectivity data, the second connectivity data and the gateway data.

12. The method according to claim 1, further comprising retrieving a reference data format for the data object for the data object;
wherein format executable data for which the format base code is intended is arranged to convert the data object from the first data format to the reference data format and from the reference data format to the second data format.

13. A non-transitory computer-readable medium having executable code stored thereon for causing a computer, when the code is loaded in a memory connected to a processing unit of the computer, to execute a method of providing an electronic data interface platform for communication of a data object from a first electronic system to a second electronic system, the method comprising:
receiving a first system reference of the first electronic system;
receiving a second system reference of the second electronic system;
receiving a data object reference of the data object;
retrieving, using the first system reference, from an electronic reference database, first system connectivity data related to the first electronic system;
retrieving, using the second system reference, from the electronic reference database, second system connectivity data related to the second electronic system;
retrieving, from an electronic code repository, based on the first system connectivity data and the second system connectivity data, format base code for establishing format executable data arranged to convert the data object from a first data format related to the first electronic system to a second data format related to the second electronic system;
retrieving, from the electronic code repository, based on at least one of the first system connectivity data and the second system connectivity data, gateway base code for establishing gateway executable data arranged to establish a communication gateway between the first electronic system and the second electronic system for transfer of the data object in the first data format from the first electronic system to the second electronic system, in the second data format;
providing the data interface platform by compiling the format executable data and the gateway executable data to provide an executable data object; and
storing the executable data object on an electronic storage medium.

14. A system comprising a processing unit programmed to executed a method of providing an electronic data interface platform for communication of a data object from a first electronic system to a second electronic system, the method comprising:
receiving a first system reference of the first electronic system;
receiving a second system reference of the second electronic system;
receiving a data object reference of the data object;
retrieving, using the first system reference, from an electronic reference database, first system connectivity data related to the first electronic system;
retrieving, using the second system reference, from the electronic reference database, second system connectivity data related to the second electronic system;
retrieving, from an electronic code repository, based on the first system connectivity data and the second system connectivity data, format base code for establishing format executable data arranged to convert the data object from a first data format related to the first electronic system to a second data format related to the second electronic system;
retrieving, from the electronic code repository, based on at least one of the first system connectivity data and the second system connectivity data, gateway base code for establishing gateway executable data arranged to establish a communication gateway between the first electronic system and the second electronic system for transfer of the data object in the first data format from the first electronic system to the second electronic system, in the second data format;
providing the data interface platform by compiling the format executable data and the gateway executable data to provide an executable data object; and
storing the executable data object on an electronic storage medium.
